(19) United States
(12) Patent Application Publication
(10) Pub. No.: US 2006/0230242 A1
(43) Pub. Date: Oct. 12, 2006

(54) Memory for multi-threaded applications on architectures with multiple locality domains

(76) Inventor: Virendra Kumar Mehta, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/104,024

(22) Filed: Apr. 12, 2005

(51) Int. Cl. G06F 13/00

(52) U.S. Cl. 711/154

(57) ABSTRACT

Embodiments of the invention relate to multi-threaded and multi-locality-domain applications. In an embodiment, memory in the form of linked lists for each locality domain is allocated in which a linked list of buffers from the same locality domain is created for that locality domain. When a thread requests memory, e.g., for an object, the processor on which the thread is running is determined, and, based on the processor information, the locality domain on which the thread is running is determined. Based on the locality domain information, the list of buffers corresponding to the locality domain is identified, and, from the identified list of buffers, memory is provided to the requesting thread.

### FIELD OF THE INVENTION

The present invention relates generally to multi-threaded applications running on multi-locality-domain systems and their memory performance.

### BACKGROUND OF THE INVENTION

Locality domains, as known by those skilled in the art, refer to a group of processors that have the same latency to a set of memory. A processing cell that includes a plurality of processors and memory is an example of a locality domain because the processors on that locality domain have the same latency to the memory in that same cell. In multi-threaded and multi-locality-domain applications, the threads' memory may be striped across multiple locality domains, which may lead to a thread running on a locality domain but using memory from another locality domain, resulting in slower memory access due to additional memory latency between locality domains. In some approaches, as a thread asks for memory, the memory is granted from the local locality domain if this locality domain has enough memory available locally. However, these approaches do not work in many situations such as where memory is formed from different locality domains as a pool and provided, when requested, in a predefined mechanism. For example, in Java applications, the requested memory from a thread is allocated from the Java run-time heap memory, which is a common pool of memory, without the thread having any control on which locality domain the memory is from. Generally, at initialization of a Java application, a heap with a pre-determined size is created to provide memory for the entire application. The memory that comprises the heap may be from various different locality domains. When a thread requests an object, memory for that object is allocated from the heap, and this memory may not be on the same locality domain as the one that the thread is running.

### SUMMARY OF THE INVENTION

Embodiments of the invention relate to multi-threaded and multi-locality-domain applications. In an embodiment related to multiple processing cells, which are a type of locality domains, memory in the form of linked lists of buffers for each cell is allocated in which memory constituting the buffers for a cell is created from the same cell. When a thread requests memory, e.g., for an object, the processor on which the thread is running is determined, and, based on the processor information, the cell on which the thread is running is determined. Based on the cell information, the linked list of buffers corresponding to the cell is identified, and from the identified list of buffers, memory is provided to the requesting thread. Other embodiments are also disclosed.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows a system upon which embodiments of the invention may be implemented.

FIG. 2 shows a processing cell of the system in FIG. 1, in accordance with an embodiment.

FIG. 3 shows a heap used in the arrangement of FIG. 1, in accordance with an embodiment.

FIG. 4 shows a flowchart illustrating a method embodiment of the invention.

### DETAILED DESCRIPTION OF VARIOUS EMBODIMENTS

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

### Overview

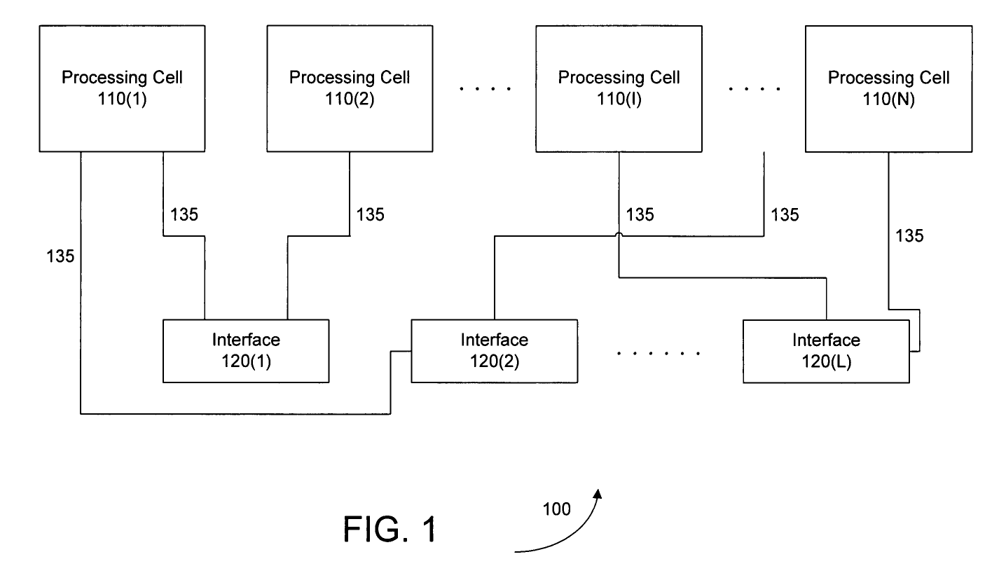

FIG. 1 shows a system 100 upon which embodiments of the invention may be implemented. System 100 includes a plurality of processing cells, e.g., cells 110(1) to 110(N) and a plurality of interfaces 120, e.g., interfaces 120(1) to 120(L). System 100 is a SMP (Symmetric MultiProcessing) system in which multiple CPUs can complete individual processes simultaneously. An idle CPU can be assigned any task, and additional CPUs can be added to handle increased loads and improve performance. A thread may be initiated by one CPU and subsequently run on another CPU. One or a plurality of processing cells 110 may be selected to form a system running an operating system. In an embodiment, information related to a thread, the CPU and/or the cell on which the thread is running is kept in a data structure corresponding to the thread, and this data structure is accessible by the Java Virtual Machine (JVM) via the Java memory manager. Consequently, using this data structure and the identity of the thread, the JVM may identify the CPU and/or the cell on which the thread is running. Interfaces 120 enable multiple cells 110 to be connected, and if desired, one or a plurality of connected cells 110 operates as an independent computer system running an operating system image. Generally, the operating system creates processes which own threads. Data is transmitted on bus 135 from one part of a computer to another, e.g., CPU, memory, etc

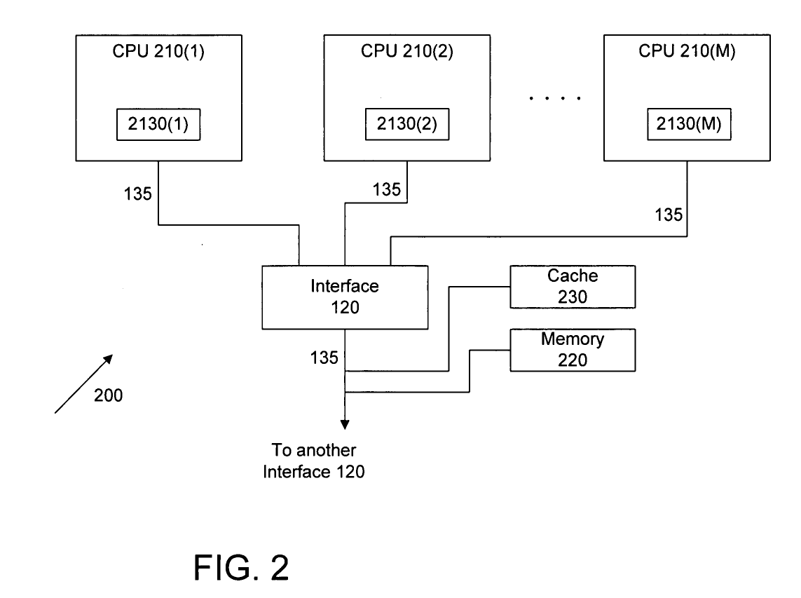

FIG. 2 shows a processing cell 200 being an embodiment of a processing cell 110. Processing cell 200 includes a plurality of processors or CPU, e.g., CPU 210(1) to 210(M), memory 220, different levels of caches 230. A CPU 210 has its own cache 2130 referred to as the CPU cache. For illustration purposes, only one cache 2130 is shown in a CPU 210. However, there may be different levels of cache 2130 internal to such CPU. Similar to the situation of cache 2130, only one cache 230 is shown in FIG. 2 for illustration purposes. However, there may be one or more caches 230 at different levels between CPUs 210 and memory 230. A thread of a CPU 210 in a cell 200 uses data stored in memory 220 and/or caches 230 and 2130 of the same cell 200 or of another cell 200.

### Memory Structure

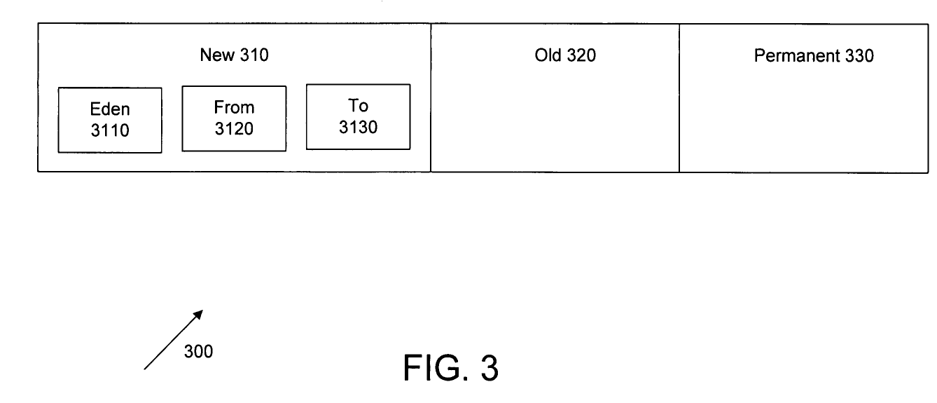

FIG. 3 shows a heap 300 for use by programs running on CPUs 210 in system 100, in accordance with an embodiment. Heap 300 includes a section “New” 310, a section “Old” 320, and a section “Permanent” 330, all of which store data based on life time of program objects. Those skilled in the art will recognize that heap 300 may be referred to as a generational heap because data in the sections of heap 300 are of different “age” generations. Further, sections New 310 and Old 320 may be referred to as sections “Young” and “Tenured,” respectively. When an object is newly created, it is stored in section New 310. After several garbage collections the number of which varies depending on embodiments, if an object still exists in section New 310, the object is moved into section Old 320. Generally, section Old 320 stores global variables. Section Permanent 330 provides memory that is needed for the entire life of an application. Examples of such memory include Java classes. The age of objects in different sections of heap 300 varies, depending on embodiments and/or policy determination by system users, etc.

Section New 310 includes a section “Eden” 3110, a section “From” 3120, and a section “To” 3130. Section Eden 3110 stores temporary objects and objects that are newly allocated. Section From 3120 stores the current list of live objects while section To 3130 serves as a temporary storage for copying. Because new objects are created in section Eden 3110, the number of objects in section Eden 3110 increases as time elapses. When objects become inactive, e.g., will not be used by a program application, the objects stay in section Eden 3110 until they are picked up by the garbage collector. When section Eden 3110 is full, objects that are alive, e.g., those that will be used by an application, in both section Eden 3110 and section From 3120, are copied into section To 3130. Once the copy is complete, the name of the sections From 3120 and To 3130 are swapped. That is, the previous section To 3130 becomes section From 3120 and the previous section From 3120 becomes section To 3130. Further, at this time, section Eden 3110 is empty.

Each section in heap 300 includes a plurality of buffers, commonly referred to as thread local allocation buffers (TLABs). In an embodiment, each TLAB provides memory for a plurality of objects, and a plurality of TLABs forms a linked list. Generally, a linked list of TLABs for a generational section is generated at initialization of the program application. When an object is requested, memory for that object is allocated in one of the TLABs. As additional objects are requested, additional memory for the objects is allocated in the same TLABs, and if that TLABs is full, then the next TLAB, i.e., the next element in the linked list, is selected for the memory allocation. For illustration purposes, TLABs in section Eden 3110 are used to explain embodiments of the invention. However, embodiments of the invention are applicable to other sections.

### Creating TLABs Corresponding to Locality Domains

Embodiments of the invention provide memory, e.g., for requested objects, from TLABs that comprise memory being originated from the same locality domain/cell on which the thread that requests the object runs. For illustration purposes, this feature is referred to as “cell-local memory” because, in the embodiment of FIG. 1, the memory allocated for the requesting thread is local to the cell on which the thread is running. In various embodiments, program instructions are embedded as part of the JVM to perform functionality described herein. For illustration purposes, the term JVM used in this document refers to the JVM with the embedded instructions.

In an embodiment, the JVM invokes the system call mpctl to determine the number of cells that comprises a system, e.g., system 100 or other systems formed by processing cells 100 as explained above. Based on the number of cells, the JVM creates the same number of temporary threads each corresponding to a cell 110. For illustration purposes, if there are three cells 110(1), 110(2), and 110(3) in a system, then the JVM creates three temporary threads TT(1), TT(2), and TT(3). The JVM then invokes the mcptl call to assign each thread TT to a CPU 210 that reside in a cell 110, and, for illustration purposes, the JVM assigns threads TT(1), TT(2), and TT(3) to three CPUs residing in three cells 110(1), 110(2), and 110(3), respectively. As a result, threads TT(1), TT(2), and TT(3) correspond to cells 110(1), 110(2), and 110(3), respectively. Each temporary thread TT, in operation with the JVM, then uses the system call mmap to request the system kernel to provide memory that forms the TLABs in section Eden 3110. Because, in this example, three threads TT(1), TT(2), and TT(3) that correspond to three cells 110(1), 110(2), and 110(3) and that invoke the three mmap calls, the system kernel returns three chunks of memory, e.g., M(1), M(2), and M(3) for the three system calls by the three threads TT(1), TT(2), and TT(3). From the three chunks of memory M(1), M(2), and M(3), the JVM creates the three linked lists of TLABs, e.g., LTLAB(1), LTLAB(2), and LTLAB(3) to be part of section Eden 3110 and to correspond to cells 110(1), 110(2), and 110(3), respectively. Each thread TT, when invoking the mmap call, specifies the “cell-local memory” option so that the system kernel provides the memory for the TLABs from the cell on which the thread is running. For example, when thread TT(1) that runs on cell 110(1) invokes the mmap call with option “cell-local memory,” the system kernel provides memory from cell 110(1) to form LTLAB(1). Similarly, when threads TT(2) and TT(3) that run on cell 110(2) and 110(3) invoke the mmap call with the option “cell local memory,” the system kernel provides memory from cells 110(2) and 110(3) to form LTLAB(2) and LTLAB(3), respectively. In an embodiment, the size of an LTLAB, e.g., LTLAB(1), LTLAB(2), and LTLAB(3) equals the size of an LTLAB of section Eden 3110 had the cell-local memory feature is off divided by the number of cells used in the system. For example, if the size of an LTLAB for section Eden 3110 had the cell-local memory feature is off is S, then the size of each LTLAB(1), LTLAB(2), and LTLAB(3) is S/3. However, embodiments of the invention are not limited to the size of the TLABs or how such size is determined. Once the LTLABs, e.g., LTLAB(1), LTLAB(2), and LTLAB(3), are created, temporary threads TT(1), TT(2), and TT(3) are terminated.

### Providing Memory from the Created LTLABs

Embodiments of the invention also include program instructions embedded in the JVM to allocate memory from the LTLABs created as described above. When a thread, e.g., thread T, requests memory, e.g., for an object, and if a TLAB has been assigned to that thread T, then the JVM, having such information, continues to allocate the memory from that TLAB to the requesting thread T. Generally, this situation arises when the thread T had previously requested memory, and, as a result, a TLAB in an LTLAB was assigned to provide memory to that thread T. However, if no TLAB has been assigned to the thread T such as when this is the first time the thread T asks for memory, the thread recently migrates to a new locality domain, the TLAB that was assigned to the thread T cannot service the request such as when the requested memory is larger than the space left in the assigned TLAB, etc., then the JVM, using an mpctl call with an appropriate attribute, determines the cell on which the thread is running. Alternatively, the JVM determines the CPU on which thread T is running, and, based on the CPU number and a calculation based on the number of CPUs per cell, the JVM determines the cell that contains the CPU or, in fact, the cell on which thread T is running. The JVM then allocates memory for that object in a TLAB of the LTLAB corresponding to that cell. For example, if thread T is running on a CPU of cell 110(1), then the JVM allocates memory from TLABs of LTLAB(1) for the requested object. Similarly, if thread T is running on a CPU of cell 110(2), then the JVM allocates memory from TLABs of LTLAB(2) for the requested object, etc. As thread T requests subsequent objects, memory for these objects are provided from the same TLAB of the same LTLAB until this TLAB is full. Once the TLAB is full, another TLAB, e.g., the TLAB next in the linked list, in the same LTLAB is selected to provide memory for the requested object.

When a thread is initiated from a cell, e.g., cell 110(1), and the thread is later migrated to another cell, e.g., cell 110(2), the memory allocated for the newly requested objects from that thread are from the new cell, e.g., cell 110(2). In an embodiment, program instructions provide options, e.g., through a flag, to turn on or off the cell-local-memory feature.

Because embodiments of the invention provide memory requested by a thread on the same cell that the thread is running, memory latency problems improve as compared to other approaches in which memory for a thread may be distributed in various different cells.

### Illustrative Method Embodiment

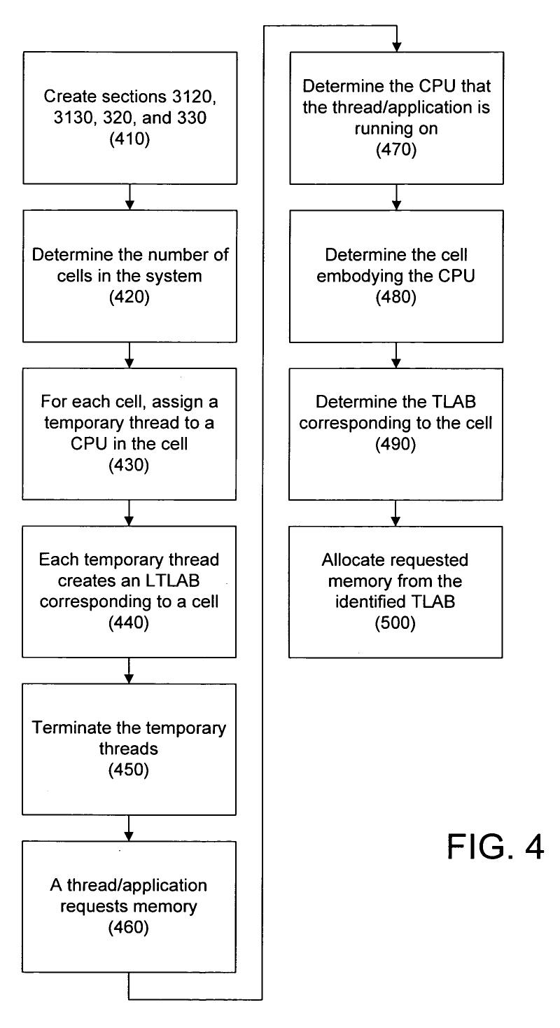

FIG. 4 shows a flowchart 400 illustrating a method embodiment of the invention.

In block 410, the JVM invokes mmap calls to acquire memory from which the JVM creates section From 3120, section To 3130, section Old 320, and section Permanent 330.

In block 420, the JVM determines the number of cells in the system. For illustration purposes, there are three cells 110(1), 110(2), and 110(3).

In block 430, for each cell identified in the system, the JVM assigns a temporary thread to a CPU in the cell, e.g., threads TT(1), TT(2), and TT(3) to a CPU in each of the cells 110(1), 220(2), and 110(3), etc.

In block 440, each thread invokes an mmap call to create LTLABs for section Eden 3110. Because, in this example, there are three threads corresponding to three cells, there are three LTLABs in section Eden 3110, e.g., LTLAB(1), LTLAB(2), and LTLAB(3).

In block 450, the JVM terminates the temporary threads.

In block 460, an application/thread, e.g., thread T, requests memory allocation, and, for illustration purposes, assume that no TLAB has been assigned to the thread T or the TLAB assigned to it cannot service the request. As a result, a new TLAB in an LTLAB is desirable to provide the requested memory.

In block 470, the JVM determines the CPU that thread T is running on, and, for illustration purposes, this is CPU 210(1).

In block 480, based on the CPU information, the JVM determines the cell that thread T is running on, and, for illustration purposes, this is cell 110(1).

In block 490, the JVM determine the LTLAB corresponding to cell 110(1), and, as in block 440, this is LTLAB(1).

In block 500, the WM causes memory in a TLAB of LTLAB(1) to be allocated for the requested memory.

### Mpctl Calls

In embodiments related to mpctl calls, there are associated attributes that, in conjunction with the mpctl call, provide the desired information. Following are some examples of the attributes and corresponding information when the attributes are used:

MPC_GETNUMLDOMS: provides the number of cells/locality domains (“LDOMs”) enabled in a system and an array of LDOM identification (“id”) for each LDOM.

MPC_GETFIRSTLDOM: provides the id of the first LDOM in the array provided by MPC_GETNUMLDOMS

MPC_GETNEXTLDOM: provides the id of the next LDOM in the array provided by MPC_GETNUMLDOMS

MPC_SETLWPLDOM: assigns a cell to a processor in an LDOM

Other attributes are available and may be used as appropriate by those skilled in the art.

For example, to acquire the number of LDOMS enabled in the system, an mpctl call with the attribute MPC_GETNUMLDOMS may be used in which the index and/or the number of elements in the array provide the number of LDOMS. Further, the first LDOM in the array may be identified by using an mpctl with the attribute MPC_GETFIRSTLDOM because such call provides the id of the first LDOM in the array provided by the call with MPC_GETNUMLDOMS. Similarly, assuming there are n LDOMS in the system, the n-I calls with the attribute MPC-GETNEXTLDOM provides the ids of the rest of the LDOMs in the array. For another example, based on the acquired number of LDOMs in the system, the number of temporary threads TT may be created, using the attribute MPC_GETSETLWPLDOM along with the corresponding LDOM id, etc.

### Computer

A computer may be formed by various processing cells 110, and can run program applications, the JVM 120, etc., to perform embodiments in accordance with the techniques described in this document, etc. For example, a CPU (Central Processing Unit) of the computer executes program instructions implementing the JVM by loading the program from a CD-ROM to RAM and executes those instructions from RAM. The program may be software, firmware, or a combination of software and firmware. In alternative embodiments, hard-wire circuitry may be used in place of or in combination with program instructions to implement the described techniques. Consequently, embodiments of the invention are not limited to any one or a combination of software, firmware, hardware, or circuitry.

Instructions executed by the computer may be stored in and/or carried through one or more computer readable-media from which a computer reads information. Computer-readable media may be magnetic medium such as, a floppy disk, a hard disk, a zip-drive cartridge, etc.; optical medium such as a CD-ROM, a CD-RAM, etc.; memory chips, such as RAM, ROM, EPROM, EEPROM, etc. Computer-readable media may also be coaxial cables, copper wire, fiber optics, acoustic, electromagnetic waves, capacitive or inductive coupling, etc.

In the foregoing specification, the invention has been described with reference to specific embodiments thereof. However, it will be evident that various modifications and changes may be made thereto without departing from the broader spirit and scope of the invention. Further, for illustration purposes, “processing cells” are used to explain embodiments of the invention. However, the invention is not limited to cells, but is also applicable to locality domains and the like. Accordingly, the specification and drawings are to be regarded as illustrative rather than as restrictive.

What is claimed is:

1. A method for providing memory in a multi-locality-domain system, each locality domain being associated with first memory, comprising:
in a heap comprising a pool of memory for the multi-locality-domain system, for each locality domain, providing second memory from the first memory, resulting in each locality domain corresponding to its second memory in the heap;
upon memory being requested from an application;
determining a locality domain on which the application is running; and
providing the requested memory from the second memory in the heap that corresponds to the locality domain on which the application is running.

2. The method of claim 1 wherein providing the second memory from the first memory for each locality domain comprising the step of:
for each locality domain,
assigning a thread to a CPU in the locality domain, and
the thread requesting memory to form the second memory corresponding to the locality domain.

3. The method of claim 2 wherein, to request memory to form the second memory corresponding to the locality domain, the thread specifies that the thread desires the memory from the first memory in the locality domain on which the thread is running.

4. The method of claim 1 wherein the second memory corresponding to a locality domain includes a plurality of buffers.

5. The method of claim 1 wherein the heap is for use by a Java application.

6. The method of claim 1 wherein providing the requested memory from the second memory in the heap that corresponds to the locality domain on which the application is running comprises:
determining a processor on which the application is running; and
determining a locality domain that includes the processor.

7. The method of claim 1 wherein determining the locality domain on which the applications is running arises when a new buffer in the second memory is desirable to provide the requested memory.

8. The method of claim 1 wherein the new buffer in the second memory is desirable when the application requests memory for the first time, a thread of the application has migrated to a new locality domain, or a buffer that was assigned to the application cannot provide the requested memory.

9. A system comprising:
a plurality of locality domains each of which includes at least one CPU and first memory;
a heap serving as a pool of memory for use by programs running on the system, and includes
a plurality of chunks of second memory, each chunk corresponding to a locality domain and being formed from the first memory in the locality domain;
wherein
upon memory being requested from a program, the requested memory is provided from a chunk of the second memory corresponding to a locality domain on which the program is running; and
the locality domain on which the program is running is determined based on one or a combination of a processor on which the program is running and an identity of the locality domain.

10. The system of claim 9 further comprising a Java Virtual Machine that includes program instructions for creating the plurality of chunks of the second memory and for providing the requested memory.

11. The system of claim 9 wherein a chunk of the second memory includes a plurality of buffers formed as a linked list.

12. A heap created from memory of a plurality locality domains, comprising:
a plurality of linked lists of buffers wherein
a linked list corresponds to a locality domain, and
the buffers of the linked list are created from memory of that locality domain;
wherein upon a request for memory from a program, if a buffer has been assigned to provide memory to the program, then the requested memory is provided from this buffer, else if no buffer has been assigned to provide memory to the program, then the requested memory is provided from a buffer of a linked list selected based on a locality domain on which the program is running.

13. The heap of claim 12 further comprising a plurality of sections for storing data based on life time of objects of program applications wherein the plurality of linked lists of buffers are part of at least one section.

14. The heap of claim 12 wherein the plurality of locality domains form a symmetric multi processing system running Java applications.
